(19) United States
(12) Patent Application Publication
(10) Pub. No.: US 2003/0146036 A1
(43) Pub. Date: Aug. 7, 2003

(54) Hollow or structural part of a motor vehicle

(76) Inventors: Thomas Nording, Esslingen (DE); Michael Bott, Freiberg am Neckar (DE); Uwe Grass, Ottweiler (DE)

Correspondence Address: M Robert Kestenbaum, 11011 Bermuda Dune NE, Albuqueruqe, NM, 87111, US

(21) Appl. No.: 10/297,967

(22) PCT Filed: Apr. 5, 2001
(86) PCT No.: PCT/EP01/03872

(30) Foreign Application Priority Data
Jun. 15, 2000 (EP) 100 29 389.1

(51) Int. Cl. B60K 13/04

(52) U.S. Cl. 180/309

(57) ABSTRACT

The invention relates to a hollow part (7, 11) of a chassis, running gear, or superstructure of a motor vehicle (1) that is driven by a combustion engine (4), whose exhaust gases are discharged into the atmosphere via an exhaust gas pipe assembly (12). Said part is characterised in that it is configured or positioned as an integral part of the exhaust gas pipe assembly.

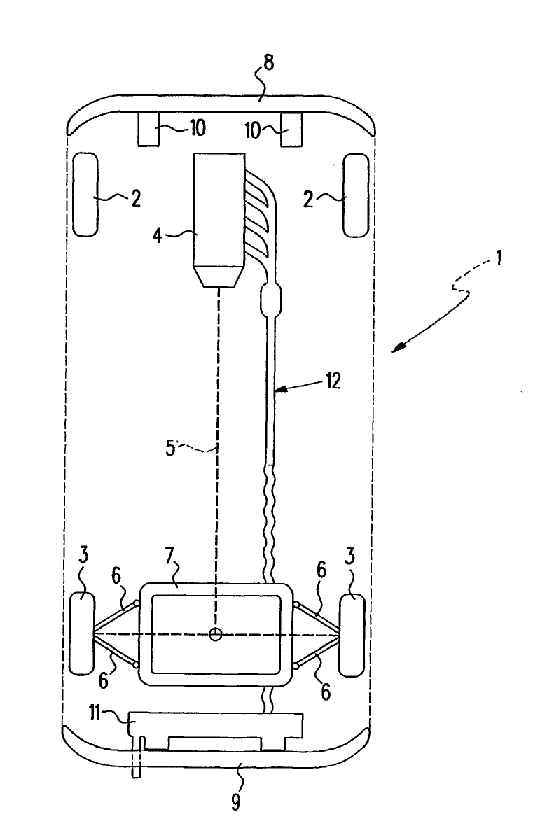

The invention relates to a hollow-chamber portion, or a structural portion having cavities, of a chassis, undercarriage or structure of a motor vehicle which is, or can be, driven by an internal combustion engine, the exhaust gases of which flow out through an exhaust gas system into the atmosphere.

On present-day motor vehicles, structural portions which can be mechanically loaded are generally constructed as hollow-chamber portions, and indeed often in the form of shell portions. High structural strength can be attained in this fashion with comparatively low production cost.

An example of mechanically loadable hollow-chamber portions in present-day motor vehicles is also the exhaust gas system, which generally has a long lifetime in spite of loading by pulsations and vibrations and also of corroding components and comparatively high temperature of the exhaust gases.

The invention now has as its object to make possible a further rationalization.

This object is attained in that a hollow-chamber portion or structural portion of the chassis, undercarriage, or structure of a motor vehicle is constituted or arranged as a portion of the exhaust gas system.

The invention is based on the general concept of making use for the exhaust system of the cavities which are already present in the undercarriage, chassis or vehicle structure, so that separate elements for the exhaust system can be at least partially dispensed with.

The invention uses the knowledge that the exhaust gases of modern engines with high thermal efficiency have comparatively low temperatures and accordingly lead to a reduced thermal loading of the exhaust gas system. This is particularly the case for exhaust gas systems with nitrogen oxide storage [sic] catalysts.

The invention furthermore offers the advantage that comparatively large volumes can be made available for the exhaust gas system, with the consequence that a wide noise spectrum, particularly also noises with low frequencies, can be effectively damped.

Furthermore, as regards preferred features of the invention, reference is made to the claims and to the following explanation of the drawing, using which a particularly preferred embodiment is described in detail.

The single FIGURE shows a schematic plan view of a motor vehicle, in which hollow-chamber structural portions are arranged in the exhaust gas system of the internal combustion engine driving the motor vehicle.

A motor vehicle 1, shown only schematically, has steerable front wheels 2 and driven rear wheels 3. The drive takes place by means of an internal combustion engine 4 and a drive train 5, shown only schematically by dashed lines.

The driven wheels 3 are connected in a basically known fashion by means of wheel radius arms 6 on an auxiliary frame 7 separated from the vehicle structure (not shown) and constituted as a hollow-chamber shell portion.

The vehicle 1 furthermore has front and rear fenders 8 and 9, which are connected by means of front and rear impact absorbers 10 and 11 to a vehicle support structure, not shown in detail, for example a self-supporting bodywork. On a collision of the motor vehicle, the fenders 8 or 9 can yield, with irreversible deformation of the impact absorbers 10 and 11, so that severe damage to the support structure of the motor vehicle can be avoided, at least for slight collisions, and finally only the fenders 8, 9 and impact absorbers 10 or 11 have to be changed.

The impact absorbers 10 and 11 can also be constituted in a basically known fashion as hollow-chamber shell portions.

It is now provided according to the invention to connect the hollow-chambers formed by auxiliary frames 7 and/or the rear large impact absorber 11 for noise damping into an exhaust gas system 12 of the internal combustion engine 4.

The hollow chambers formed by the auxiliary frames 7 or by the impact absorber 11 can for example be connected to the exhaust gas system 12 in the fashion of resonance chambers.

The exhaust gas ducts of the exhaust gas system 12 are preferably at least partially constituted by flexible metal tubes, preferably in the form of corrugated tubes, as is schematically shown in the drawing. The transfer of vibrations in the exhaust gas system 12 can be avoided in this fashion.

1. Construction of a motor vehicle (1) which is driven by an internal combustion engine (4), the exhaust gases of which flow out into the atmosphere through an exhaust gas system (12), with a hollow-chamber portion or a structural portion having cavities (7, 11), as an exhaust gas flow portion of the exhaust gas system (12), wherein
the hollow-chamber/structure portion is at least a portion of an auxiliary frame (7) separate from the vehicle structure, or of a combined engine and axle unit.

2. Structure of a motor vehicle (1) which is driven by an internal combustion engine (4), the exhaust gases of which flow out into the atmosphere through an exhaust gas system (12), with a hollow-chamber portion or a structural portion having cavities (7, 11), as an exhaust gas flow portion of the exhaust gas system (12), if applicable according to claim 1, wherein
the hollow-chamber/structure portion is an impact absorber (11), which in collisions of the motor vehicle deforms with the absorption of energy.

3. Structure according to claim 2, wherein the hollow-chamber/structural portion is the rear impact absorber (11), which is connected to the rear fender (9) of the motor vehicle (1).

4. Structure according to one of claims 1-3, wherein exhaust ducts of the exhaust gas system (12), in which at least one hollow-chamber/structural portion through which exhaust gas flows is at lest partially formed by flexible metal tubes, preferably by corrugated flexible tubes.
